(19) United States
(12) Patent Application Publication
(10) Pub. No.: US 2023/0291759 A1
(43) Pub. Date: Sep. 14, 2023

(54) EVALUATING AN IT INFRASTRUCTURE'S VULNERABILITY TO A NETWORK ATTACK

(71) Applicant: Hewlett Packard Enterprise Development LP, Houston, TX (US)

(72) Inventors: Mohd Shahnawaz SIRAJ, San Jose, CA (US); Andre BEAUDIN, St. Laurent (CA); Qiang ZHOU, San Jose, CA (US)

(21) Appl. No.: 17/693,509

(22) Filed: Mar. 14, 2022

(51) Int. Cl. H04L 9/40

(52) U.S. Cl. CPC H04L 63/1433

(57) ABSTRACT

Examples described herein relate to a method and a management system for evaluating an information technology (IT) infrastructure's vulnerability to a network attack. The management system determines whether a vulnerability evaluation template corresponding to a network attack is uploaded in a template repository. In response to determining that the vulnerability evaluation template is uploaded in the template repository, the management system transmits the vulnerability evaluation template to a sensor deployed in the IT infrastructure. The vulnerability evaluation template, when executed by the sensor, causes the sensor to generate an assessment indicative of a vulnerability of the IT infrastructure to the network attack. The management system receives the assessment from the sensor and reports it via a dashboard.

### BACKGROUND

Information technology (IT) infrastructures may host several network devices interconnected to each other via communication networks such as a wireless network (e.g., Wireless Local Area Network (WLAN)) and/or a wired network (e.g., Ethernet-based Local Area Network (LAN)). The IT infrastructure may be a datacenter, a private network, or a public network of the network devices. During operation, the IT infrastructure may face issues such as network attacks. For example, an attacker can exploit a network attack to steal data via a Wireless Fidelity (W-Fi) network, bypassing W-Fi encryption that should be protecting the data, launch network attacks against network devices connected to the Wi-Fi network, including Internet of Things (IoT) devices, inject malicious, unencrypted W-Fi, intercept user information, and the like. Such issues may make the IT infrastructure unreliable hurting the user experience.

### BRIEF DESCRIPTION OF THE DRAWINGS

One or more examples in the present disclosure are described in detail with reference to the following figures. The figures are provided for purposes of illustration only and merely depict examples.

FIG. 1 depicts a system in which various of the examples presented herein may be implemented.

FIG. 2 depicts an example backend system hosting a management system that aids in determining whether an IT infrastructure is vulnerable to a network attack.

FIG. 3 depicts an example dashboard.

FIG. 4 depicts a flowchart of an example method for evaluating IT infrastructure's vulnerability to a network attack.

FIG. 5 depicts a flowchart of another example method for evaluating IT infrastructure's vulnerability to a network attack.

FIG. 6 depicts a block diagram of an example computing system in which various of the examples described herein may be implemented.

The figures are not exhaustive and do not limit the present disclosure to the precise form disclosed.

### DETAILED DESCRIPTION

In IT infrastructures such as a datacenter, a private or public network may host multiple network devices interconnected to each other via various wired and wireless communication networks. The IT infrastructure may be located within a single site in a particular region or distributed across several geographically separated sites. The network devices hosted in the IT infrastructure may include servers, storage devices, desktop computers, portable computers, network switches, routers, network gateways, access points, etc. An inadequately protected IT infrastructure may be susceptible to vulnerabilities. Vulnerabilities such as network attacks can cause network device failures, Internet connectivity issues, and/or increased load on the network.

Generally, network attacks are attempts to gain unauthorized access to an organization's IT infrastructure with the intent of stealing data or performing other malicious activities. Commonly known network attacks are computer viruses, malware, Denial of Service (DoS) and Distributed DoS (DDoS) Attacks, Ransomware, Man-in-the-middle (MitM) attack, Structured Query Language (SQL) injection attack, Eavesdropping attack, Fragmentation and Aggregation attacks (FragAttacks), or the like. Hackers may try to find ways to break into the IT infrastructures having inadequate protection. For example, an attacker may exploit one or more network attacks to steal data via a Wi-Fi network bypassing Wi-Fi encryption that should be protecting the data, launch network attacks against devices connected to the Wi-Fi network, inject malicious content/information, intercept user information, and the like. Such vulnerabilities may make the IT infrastructure unreliable resulting in a negative user experience due to issues caused by the network attacks.

Typically, support engineers are notified about the issues faced in the IT infrastructure after such issues are reported by the users through appropriate issue-reporting techniques (e.g., calling customer care contact numbers, logging an issue in a customer service portal, etc.). After an issue is reported, a support engineer may be assigned to execute testing procedures to diagnose and resolve the reported issue. Although testing procedures are capable of gathering substantial analytic information about the IT infrastructure and the reported issue, there are some practical difficulties associated with executing these testing procedures. Typically, the support engineer manually executes these test procedures, which requires a large amount of effort and a sophisticated understanding of networking principles. Moreover, actual user interactions with some services and applications are complex and difficult to replicate with the test procedures, causing a deviation between the user's experience and data collected via the test procedures. This deviation may result in inadequate or inaccurate collection of granular data that is needed to analyze the reported issue. Hence without such granular data, it may be difficult for the support engineers to perform root-cause analysis to resolve the issues. Often, as the support engineers may not have direct access to a user's environment, they face challenges translating user requests into parameters for a testing procedure (e.g., test case, test routine).

In some implementations, IT infrastructures entail using monitoring devices to provide a way to extend network analytics. Such monitoring devices may be deployed at various locations of the end-user's infrastructure (e.g., different floors of the building, different offices, etc.). The support engineers may use the information gathered from the monitoring devices to perform network tests. The monitoring devices also provide information that can be used to identify the root cause of the issue automatically, which is particularly useful when conducting remote deployments. Typically, such monitoring devices may detect issues only after the issues have occurred, thus indicating that attempts to protect the IT infrastructure from the network attack have failed.

It is beneficial if the network devices are proactively protected against such network attacks so that the IT infrastructure can withstand the network attacks without being affected. Generally, whenever a new network attack is detected, device manufacturers fix the issues in the software/operating system that is executing on the network devices that are vulnerable to such attacks. Firmware upgrades are often required on such network devices to defeat such attacks. In existing deployments, for example, in enterprise deployments, it is typically the IT admin's responsibility to ensure that the network devices are safe and secure. Checking whether the network devices are safe and secure from the network attacks requires a painfully manual process of checking with the network equipment providers if their software is susceptible to a particular attack.

In accordance with some examples, a management system and a method for proactively protecting an IT infrastructure from network attacks are presented. The management system may be hosted on a backend system deployed on a cloud. The management system configures the IT infrastructure such that the IT infrastructure remains unaffected from the adverse impacts of the network attack with minimal or no human intervention. To achieve such protection, the proposed management system entails the use of one or more sensors. The sensors are deployed in an IT infrastructure that is to be protected. A “sensor” as used herein may refer to a client device deployed in the IT infrastructure, and which works under the control of the management system to perform tests on the IT infrastructure.

In some examples, the backend system includes a template repository that stores vulnerability evaluation templates corresponding to one or more network attacks. A vulnerability evaluation template corresponding to a given network attack may be a set of program instructions or a packaged application which, when executed, may help in determining whether an IT infrastructure is vulnerable to the given network attack. A vulnerability evaluation template for a given network attack may refer to a program module including a set of program instructions useful in evaluating whether the IT infrastructure is susceptible to the given network attack. The management system may proactively scout for a newly reported network attack by searching through predefined network sources. If a newly reported network attack is identified, the management system may as well proactively search various sources on the Internet for a test that can be used to simulate the network attack and in turn, determine if the IT infrastructure is vulnerable to the discovered network attack. The management system may then upload the test on the template repository as a vulnerability evaluation template. If the test corresponding to the newly reported network attack is not found, in some examples, a network engineer may create such a test and upload the test on the template repository as the vulnerability evaluation template. Likewise, the template repository may be updated with vulnerability evaluation templates corresponding to several network attacks.

During operation, the management system may perform a check to determine whether a new vulnerability evaluation template corresponding to a network attack is uploaded in the template repository. In response to determining that the new vulnerability evaluation template is uploaded in the template repository, the management system transmits the vulnerability evaluation template to the sensor. The sensor may execute the vulnerability evaluation template which results in the sensor generating an assessment indicative of a vulnerability of the network to the network attack. In particular, the assessment may indicate whether the IT infrastructure has passed a vulnerability test indicative of the network's capability of withstanding the network attack. In some examples, the assessment may also include information about the network devices that are found vulnerable to the network attack.

The sensor transmits the assessment to the management system. The management system then reports the assessment via a dashboard. The dashboard may be displayed on a website or an application that is accessible to a network administrator of the IT infrastructure. In some examples, the management system may also send a notification to the network administrator in case the IT infrastructure is identified to be vulnerable to the network attack. Also, in some examples, the management system may recommend, via the dashboard or a notification, corrective action to secure the IT infrastructure with respect to the network attack. The corrective action may include one or more of a firmware update, a software update, a configuration change, and/or a security patch for the network devices that are found vulnerable to the network attack. Upon implementing the corrective action or upon determining that the IT infrastructure has passed the vulnerability test, the IT infrastructure is considered to be capable of withstanding the network attack.

As will be appreciated, the management system proactively collects information about newly discovered network attacks and respective tests to simulate the same with minimal or no manual intervention. Also, the management system deploys the vulnerability evaluation template proactively without any manual intervention upon determining that the template repository is loaded with such a vulnerability evaluation template. This results in a faster and more cost-effective way of protecting IT infrastructures from network attacks. The management system evaluating IT infrastructure's vulnerability by proactively transmitting the vulnerability evaluation template to the sensor results in reduced manual intervention. Also, the management system aids in early detection of the attacks and prepares the IT infrastructure to mitigate the attack. As a result, in cases of any such future network attack, the IT infrastructure remains protected leading to an improved user experience. Also, the dashboard allows the network administrator to monitor the assessment on a real-time basis and take useful actions. Furthermore, due to the nature of the sensor's environment, a cloud-hosted backend computing device (e.g., the management system) may be better suited to deploy the vulnerability evaluation templates, quickly and efficiently, across several sensors in the IT infrastructure.

The following detailed description refers to the accompanying drawings. Wherever possible, the same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

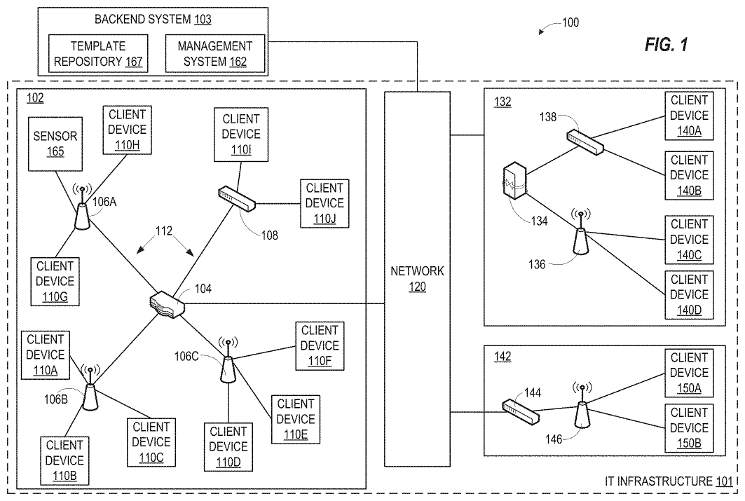

Before describing examples of the disclosed systems and methods in detail, it is useful to describe an example network installation with which these systems and methods might be implemented in various applications. FIG. 1 illustrates a system 100 in which various of the examples presented herein may be implemented. The system 100 may include an IT infrastructure 101 and a backend system 103 that aids in managing security aspects of the IT infrastructure 101. The backend system 103 may be hosted on a network outside the IT infrastructure 101 or within the IT infrastructure 101. In some examples, the backend system 103 may be deployed on a cloud platform hosted on a public, private, or hybrid cloud outside the IT infrastructure 101.

The IT infrastructure 101 may be a network of devices (hereinafter referred to as network devices) implemented for an organization, such as a business, educational institution, governmental entity, healthcare facility, or other organization. This diagram illustrates an example IT infrastructure implemented for an organization having multiple users and possibly one or more physical or geographical sites, for example, a primary site 102, and/or remote sites 132, 142. The primary site 102 and/or the remote sites 132, 142 are in communication with each other via a network 120. Although, in some examples, the IT infrastructure 101 may be implemented with a single site, without limiting the scope of the present disclosure.

The primary site 102 may include a primary network, which can be, for example, an office network, home network, or other network installation. The primary site 102 may be a private network, such as a network that may include security and access controls to restrict access to authorized users of the private network. For example, the authorized users may include employees of a company at the primary site 102, residents of a house, customers at a business, and so on. In the illustrated example, the primary site 102 is shown to include a controller 102 in communication with the network 120. The controller 104 may provide communication with the network 120 for the primary site 102, though it may not be the only point of communication with the network 120 for the primary site 102. A single controller 104 is illustrated, though the primary site 102 may include multiple controllers and/or multiple communication points with network 120. In some examples, the controller 104 may communicate with the network 120 through a router (not shown). In other implementations, the controller 104 may provide router functionality to the devices in the primary site 102.

The controller 104 may be operable to configure and manage network devices, such as at the primary site 102, and may also manage network devices at the remote sites 132, 142. The controller 104 may be operable to configure and/or manage switches, routers, APs, and/or client devices connected to a network. The controller 104 may itself be, or provide the functionality of, an AP. In some examples, the controller 104 may be in communication with one or more switches 108 and/or wireless APs 106A-106C. The switches 108 and the wireless APs 106A-106C may provide network connectivity to various client devices 110A-110J. Using a connection to the switch 108 or one or more of the AP 106A-106C, one or more of the client devices 110A-110J may access network resources, including other devices on the (primary site 102) network and the network 120. Examples of client devices 110A-110J may include, but are not limited to, desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, smart terminals, dumb terminals, virtual terminals, video game consoles, virtual assistants, IOT devices, and the like.

Within the primary site 102, the switch 108 is included as one example of a point of access to the network established in primary site 102 for wired client devices 1101 and 110J, for example. The client devices 1101 and 110J may connect to the switch 108 and through the switch 108, may be able to access other devices within the IT infrastructure 101. The client devices 1101 and 110J may also be able to access the network 120, through the switch 108. The client devices 1101 and 110J may communicate with the switch 108 over a wired connection 112. In the illustrated example, the switch 108 may communicate with the controller 104 over a wired connection 112, though this connection may also be wireless, in some examples.

The wireless APs 106A-106C are included as another example of a point of access to the network established in primary site 102 for client devices 110A-110H. Each of APs 106A-106C may be a combination of hardware, software, and/or firmware that is configured to provide wireless network connectivity to wireless client devices 110A-110H. In the illustrated example, the APs 106A-106C can be managed and configured by the controller 104. The APs 106A-106C may communicate with the controller 104 and the network 120 over connections 112, which may be either wired or wireless interfaces.

The IT infrastructure 101 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, the remote site 132 may utilize a connection over a different network, e.g., the network 120. The remote site 132 such as the one illustrated in FIG. 1 may be, for example, a satellite office, another floor, or suite in a building, and so on. The remote site 132 may include a gateway device 134 for communicating with the network 120. The gateway device 134 may be a router, a digital-to-analog modem, a cable modem, a Digital Subscriber Line (DSL) modem, or some other network device configured to communicate to the network 120. The remote site 132 may also include a switch 138 and/or an AP 136 in communication with the gateway device 134 over either wired or wireless connections. The switch 138 and the AP 136 may provide connectivity to the network for various client devices 140A, 140B, 140C, and 140D (hereinafter collectively referred to as client devices 140A-140D).

In various examples described herein, the remote site 132 may be in direct communication with the primary site 102, such that client devices 140A-140D at the remote site 132 access the network resources at the primary site 102 as if these client devices 140A-140D were located at the primary site 102. In such examples, the remote site 132 may be managed by the controller 104 at the primary site 102, and the controller 104 may provide the necessary connectivity, security, and accessibility that enable the remote site 132's communication with the primary site 102. Once connected to the primary site 102, the remote site 132 may function as a part of a private network provided by the primary site 102.

In various examples, the IT infrastructure 101 may include one or more smaller remote sites 142, comprising a gateway device 144 for communicating with the network 120 and a wireless AP 146, by which various client devices 150A, 150B access the network 120. Such a remote site 142 may represent, for example, an individual employee's home or a temporary remote office. The remote site 142 may also be in communication with the primary site 102, such that the client devices 150A, 150B at remote site 142 access the network resources at the primary site 102 as if these client devices 150A, 150B were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or another communication network to allow connectivity among the various sites 102, 132, 142, and the backend system 103. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the IT infrastructure 101 but that facilitate communication between the various parts of the IT infrastructure 101, and between the IT infrastructure 101 and other network-connected entities.

The backend system 103 hosts a management system 162 that is communicatively coupled to the IT infrastructure 101 via the network 120. The management system 162 may be a computing system, for example, a computer, a controller, a server, or a storage system hosted on a public cloud, a private cloud, or a hybrid cloud. In certain examples, the management system 162 may be any suitable device having a hardware processing resource (not shown), such as one or more central processing units (CPUs), semiconductor-based microprocessors, and/or other hardware devices suitable for retrieval and execution of instructions stored in a machine-readable storage medium (not shown). In some examples, the management system 162 may be implemented as a service running on a “cloud computing” environment or as a “software as a service” (SaaS). The management system 162 may be offered as a stand-alone product, a packaged solution, and can be utilized on a one-time full product/solution purchase or pay-per-use basis.

Further, the primary site 102 and/or the remote sites 132, 142 may host one or more sensors. For illustration purposes, in IT infrastructure 101 of FIG. 1, the primary site 102 is shown to host one such sensor, for example, a sensor 165 connected to the AP 106A. In some examples, more than one sensor may be deployed in the IT infrastructure depending on the number of APs and the number of sites in the infrastructure 101. For example, in one implementation such as an office set-up, one sensor may be deployed for every five APs. In another example implementation such as a retail store, one sensor may be deployed in one site. In yet another example implementation such as a large public venue (e.g., a stadium or a conference center) one sensor may be deployed for every ten APs.

The sensor 165 may be an example representative of the client devices 110A-110J, 140A-140D, 150A-150B. In one example, the sensor 165 may be a client device that functions in coordination with the management system 162 to evaluate whether the IT infrastructure 101 or a portion of the IT infrastructure 101 (e.g., the primary site 102) is vulnerable to network attacks. In another example, the sensor 165 may be a user experience insight sensor that is configured to mimic an end-user behavior by simulating a user and the interactions it would perform in the network. In yet another example, the sensor 165 may be a low power device, an IoT device, or any other software-defined or hardware-based device capable of collecting and transmitting data. The term “low powered device”, as used herein, refers to a device specifically designed for lower power consumption compared to typical servers or network equipment. The term “IoT device”, as used herein, refers to a hardware device, an actuator, a gadget, an appliance, or any other machine, that is programmed for a certain application and can transmit data over the internet or other networks to the management system 162. The sensor 165 may also be a mobile device, industrial equipment, environmental measurement equipment, medical device, or any other equipment. In certain examples, the sensor 165 may also be software components executing on any such equipment.

The sensor 165 may maintain a persistent or a non-persistent connection with the management system 162. Examples of the connection between the sensor 165 and the management system 162 may include a direct connection, VPN connection, Software-Defined Wide Area Networking (SDWAN) connection, wired connection, wireless connection, or any other suitable connection. Persistent connection, as used herein, refers to a network communication channel that remains open between the sensor 165 and the management system 162. Non-persistent connection, as used herein, refers to network communication that may be interrupted, established on-demand, or otherwise maintained in a non-persistent manner between the sensor 165 and the management system 162.

In accordance with some examples, the management system 162 evaluates the IT infrastructure's vulnerability to a network attack using the sensor 165. In some examples, based on the evaluation, the management system 162 may also recommend corrective actions (e.g., a firmware update, a software update, a configuration change, and/or a security patch) for the network devices that are found vulnerable. Thus, the IT infrastructure 101 may remain unaffected by the adverse impacts of the network attack. Moreover, the management system 162 performs such evaluation with minimal or no human intervention.

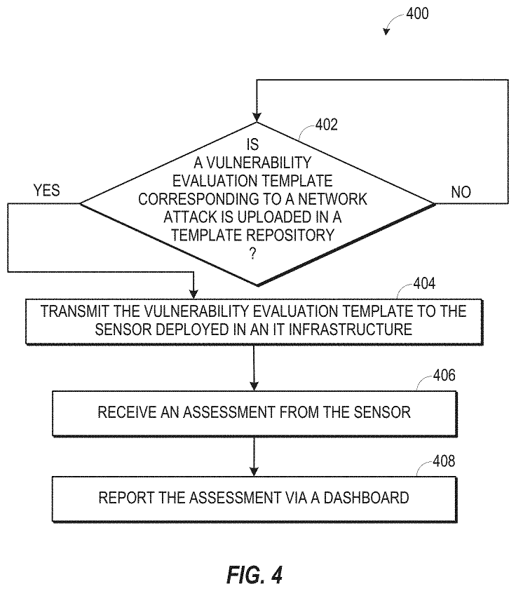

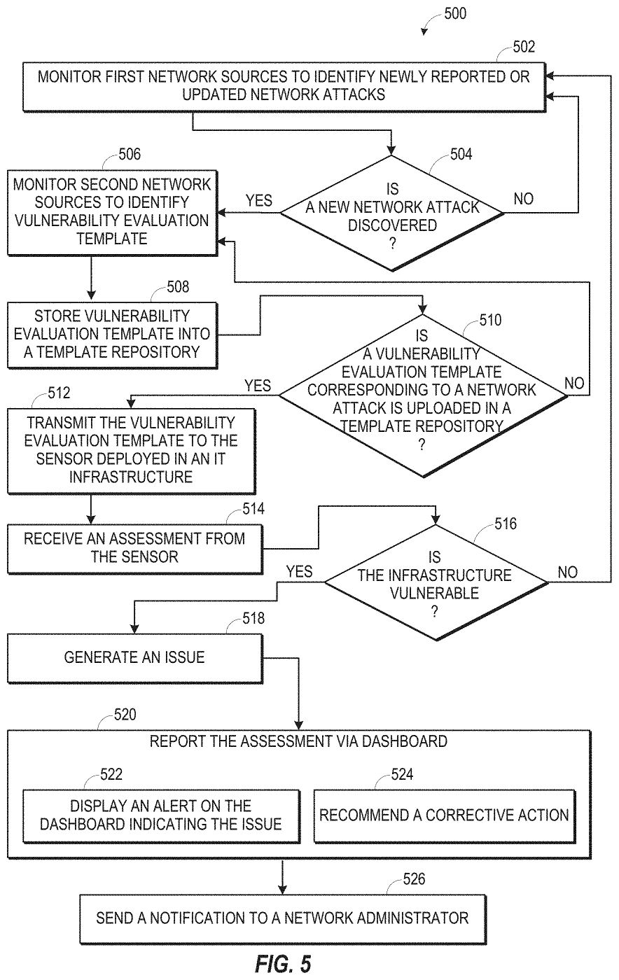

In particular, the management system 162 proactively collects information about newly discovered network attacks and respective tests to simulate the same. For example, if a new type of FragAttack is discovered, the management system 162 searches various network sources to identify any test that can simulate the discovered FragAttack. The management system 162 stores the discovered tests as vulnerability evaluation templates in a template repository 167 hosted on the backend system 103. In some examples, a vulnerability evaluation template corresponding to a given network attack may be a set of program instructions or a packaged application which, when executed, may help in determining whether an IT infrastructure is vulnerable to the given network attack. In particular, the vulnerability evaluation template corresponding to the given network attack may include a set of tests to simulate the given network attack on the IT infrastructure 101 and generate an evaluation indicative of the IT infrastructure's vulnerability. It is to be noted that description about such simulation tests and how such simulations are executed by the sensors is beyond the scope of the present disclosure. Upon determining that the new vulnerability evaluation template is uploaded in the template repository 167, the management system 162 automatically transmits the vulnerability evaluation template to the sensor 165. The sensor 165 executes the vulnerability evaluation template which results in the sensor 165 generating an assessment. The assessment is indicative of the IT infrastructure's vulnerability to a network attack. In particular, the assessment may indicate whether the IT infrastructure 101 has passed the vulnerability test indicative of the IT infrastructure's capability of withstanding the network attack. The sensor 165 may then transmit the assessment to the management system 162 which then reports the assessment via a dashboard. Additional details of operations performed by the management system 162 are described in conjunction with methods described in FIGS. 4 and 5.

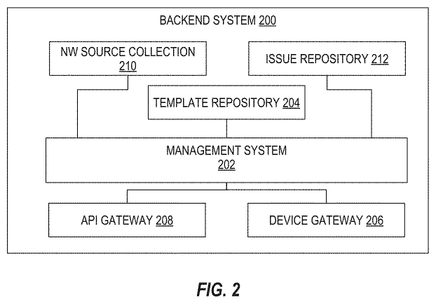

Referring now to FIG. 2, a backend system 200 is presented. The backend system 200 may be hosted on a single computing device or is distributed across multiple computing devices. In some examples, the backend system 200 may host a management system 202, a template repository 204, a device gateway 206, an application programming interface (API) gateway 208, a network source repository 210, and an issue repository 212.

The management system 202 may be an example representative of the management system 162 of FIG. 1. The management system 202 may be a computing system, for example, a computer, a controller, a server, or a storage system hosted on a public cloud, a private cloud, or a hybrid cloud. In certain examples, the management system 202 may be any suitable device having a hardware processing resource suitable for retrieval and execution of instructions stored in a machine-readable storage medium. In some examples, the management system 202 may be implemented as a service running on a “cloud computing” environment or as a “software as a service” (SaaS). The management system 202 may be offered as a stand-alone product, a packaged solution, and can be utilized on a one-time full product/solution purchase or pay-per-use basis.

The device gateway 206 may be a hardware device or software application that acts as a “gate” between the backend system 200 and the IT infrastructure. Communication between the management system 202 and sensors deployed in the IT infrastructure may be routed via the device gateway 206. For example, the management system 202 may transmit a vulnerability evaluation template to the sensor via the device gateway 206. Similarly, the sensor may transmit the assessment to the management system via the device gateway 206. The device gateway 206 may be implemented via a router, firewall, server, or another device that enables traffic to flow in and out of the network. In some examples, the device gateway 206 may also translate the assessment or any other information received from sensors into a format or protocol recognized by the management system 202, or vice versa.

The API gateway 208 may be software or a service offered via a cloud platform hosting the backend system 200. The API gateway 208 may allow developers to create, publish, maintain, and/or monitor APIs such as representational state transfer (REST) APIs and/or WebSocket APIs. In some examples, the API gateway 208 may be used to publish data to a dashboard API hosted on a user portal. In particular, the management system 202 may communicate information associated with the assessment received from the sensor to a dashboard via the API gateway 208. The API gateway 208 publishes such information to the dashboard API which in turn displays the information on the dashboard.

The network source repository 210 may be a database, a list, or a table that stores information (e.g., network end points, Uniform Resource Locators (URLs)) corresponding to a first network sources and second network sources. The management system 202 may reference the network source repository 210 to search for any newly discovered network attacks and the respective vulnerability evaluation templates. The first network sources may be sources such as websites, databases, repositories, and/or news media that maintain a record of discovered network attacks. Similarly, the second network sources may be sources such as websites, databases, repositories, and/or news media that maintain a record of vulnerability evaluation templates for known and/or newly discovered network attacks. The second network sources may be similar to the first network sources or include one or more common network sources. In some examples, the management system 202 may search for a newly reported network attack by searching through one or more of the first network sources. If a newly reported network attack is identified, the management system 202 may as well search one or more of the second network sources, to identify a test that can be used to simulate the newly reported network attack.

The template repository 204 may be a physical storage system, virtual storage, or a database. The template repository 204 stores information about the network attacks and respective vulnerability evaluation templates identified by the management system 202 or uploaded by a support engineer. During operation, the management system 202 may perform a check to determine whether a new vulnerability evaluation template corresponding to a network attack is uploaded in the template repository 204. In response to determining that the new vulnerability evaluation template is uploaded in the template repository 204, the management system 202 transmits the vulnerability evaluation template to the sensor deployed in the IT infrastructure to be evaluated. The sensor may execute the vulnerability evaluation template which results in the sensor generating an assessment indicative of the IT infrastructure's vulnerability to the network attack. In particular, the assessment may indicate whether the IT infrastructure has passed a vulnerability test indicative of the network's capability of withstanding the network attack. In some examples, the assessment may also include information about the network devices, if any, that are vulnerable to the network attack. Upon receiving the assessment, the management system 202 may generate an issue. The issue may be stored as an entry in the issue repository 212. The issue repository entry corresponding may include information about the network attack, the corresponding vulnerability evaluation template that was executed, the assessment generated by the sensor, and/or a list of network devices of the IT infrastructure that are found vulnerable to the network attack.

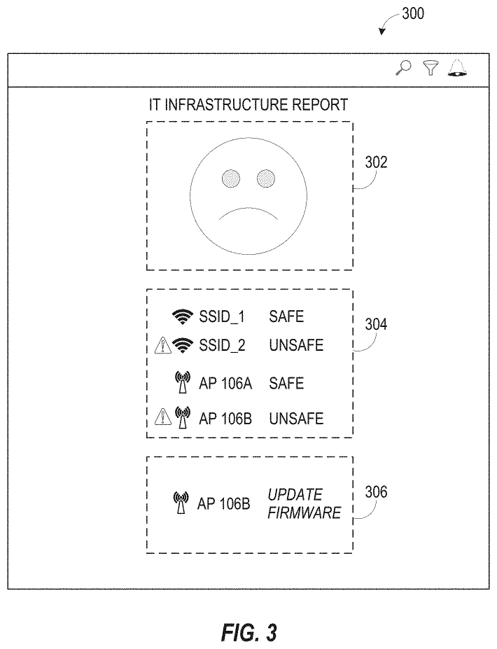

Further, in some examples, the management system 202 may report the assessment via a dashboard. In particular, the management system 202 directs the API gateway 208 to publish the information related to the issue to the dashboard API which in turn displays the information on the dashboard. FIG. 3 depicts an example dashboard 300. In some examples, dashboard 300 may be generated (or otherwise produced) by a management system and displayed (or otherwise shown) on an end-user device. The dashboard 300 may be displayed on the end-user device, for example, a mobile phone or computer upon accessing a user portal (e.g., a website) or an application. The user portal and/or the application may be hosted on a cloud. The dashboard 300 may be a simple-to-use graphical user interface (GUI) providing visibility on the performance and health of an IT infrastructure. In some examples, the dashboard 300 provides a visualization of IT infrastructure's health corresponding to network attacks across one or more sites. Using the information displayed on the dashboard 300, a network administrator can easily identify problems and perform remediation actions.

In some examples, the dashboard 300 may display a first information 302 indicating an overall security status of the IT infrastructure. In particular, the first information 302 may include visuals that indicate, at-a-glance, how the IT infrastructure has performed with respect to the network attack. In the example of FIG. 3, the first information 302 represents the overall security status using an emoji, such as, an unhappy smiley that indicates, at-a-glance, the IT infrastructure is vulnerable to the network attack based on the assessment. In some other examples, the first information 302 may represent the security status using any other emojis, symbols, pictures, text, scores, and/or color codes.

In some examples, the dashboard 300 may also display a second information 304 representing particulars of the assessment. For example, the second information 304 may include a list of network devices (e.g., APs, switches, etc.) and/or Service Set Identifiers (SSIDs) that are found vulnerable to the network attack. In some examples, the second information 304 may also include a list of network devices and/or SSIDs that are found non-vulnerable to the network attack. The vulnerable devices and/or SSIDs may be marked differently from the non-vulnerable devices and/or SSIDs, for example, using differently colored (e.g., red and green) fonts, text highlights, or by any other visual means (e.g., text identifiers such as “vulnerable” and “non-vulnerable,” or “safe” and “un-safe”).

In some examples, the dashboard 300 may also display a third information 306 including recommendations, if any, to mitigate the network attack. The recommendations may include corrective actions such as one or more of a firmware update, a software update, a configuration change, and/or a security patch for the network devices that are found vulnerable to the network attack. In some examples, the third information 306 may include instructions helpful in implementing the corrective actions. The third information 306 may also include a link to a source (e.g., website) from where the user can download relevant firmware updates, software updates, configuration changes, and/or security patches.

FIGS. 4 and 5 respectively represent example methods 400 and 500 of evaluating an IT infrastructure's vulnerability to network attacks. Each of the flowcharts of the methods 400 and 500 depicted in FIGS. 4 and 5 includes several steps in an order. However, the order of steps shown in FIGS. 4 and 5 should not be construed as the only order for the steps. The steps may be performed at any time, in any order. Additionally, the steps may be repeated or omitted as needed.

In some examples, the steps shown in FIGS. 4 and 5 may be performed by any suitable device, such as a management system. In one example, the management system may be a management system shown 162 shown in FIG. 1 or the management system 202 shown in FIG. 2. In some examples, the suitable device may include a hardware processing resource (not shown), such as one or more central processing units (CPUs), semiconductor-based microprocessors, and/or other hardware devices suitable for retrieval and execution of instructions stored in a machine-readable storage medium. The processing resource may fetch, decode, and execute instructions, to evaluate an IT infrastructure's vulnerability to network attacks. As an alternative or in addition to retrieving and executing instructions, the processing resource may include one or more electronic circuits that include electronic components for performing the functionality of one or more instructions, such as a field-programmable gate array (FPGA), application-specific integrated circuit (ASIC), or other electronic circuits. A machine-readable storage medium may be any electronic, magnetic, optical, or other physical storage device that contains or stores executable instructions. Thus, a machine-readable storage medium may be, for example, Random Access Memory (RAM), non-volatile RAM (NVRAM), an Electrically Erasable Programmable Read-Only Memory (EEPROM), a storage device, an optical disc, and the like. In some embodiments, a machine-readable storage medium may be a non-transitory storage medium, where the term “non-transitory” does not encompass transitory propagating signals.

Referring now to FIG. 4, at step 402, the management system may perform a check to determine whether a vulnerability evaluation template corresponding to a network attack is uploaded in a template repository. In one example, the management system may receive an alert when a vulnerability evaluation template is uploaded in the template repository. Responsive to the receipt of the alert the management system may determine that the vulnerability evaluation template has been uploaded in the template repository. In another example, the management system may monitor the template repository at regular intervals to look for the presence of newly uploaded vulnerability evaluation templates. In some examples, the management system itself uploads the vulnerability evaluation template to the template repository. In such a case, a successful upload of the vulnerability evaluation template may serve as a trigger to the management system indicating that the vulnerability evaluation template is uploaded in the template repository. In yet another example, the management system maintains a snapshot (e.g., a point in time copy) of the template repository. To determine whether any new vulnerability evaluation template is uploaded, the management system may compare the snapshot of the template repository with the instantaneous content of the template repository.

At step 402, if it is determined that no new vulnerability evaluation template is uploaded in the template repository (i.e., NO at step 402), the management system may continue to check for the availability of a new vulnerability evaluation template in the template repository. However, at step 402, if it is determined that a new vulnerability evaluation template is uploaded in the template repository (i.e., YES at step 402), at step 404, the management system may transmit the vulnerability evaluation template to the sensor (e.g., the sensor 165) deployed in an IT infrastructure (e.g., IT infrastructure 101). On receiving the vulnerability evaluation template, the sensor may execute the vulnerability evaluation template. Accordingly, the sensor may generate an assessment indicative of the IT infrastructure's vulnerability to the network attack. In particular, the assessment may indicate whether the IT infrastructure has passed or failed a vulnerability test corresponding to the network attack. The IT infrastructure passing the vulnerability test may be indicative of the fact that the IT infrastructure is capable of withstanding the network attack. In some examples, in case IT infrastructure has failed in the vulnerability test, the assessment generated by the sensor may also include information about the network devices in the IT infrastructure that are vulnerable to the network attack. The sensor may transmit the assessment to the management system.

At step 406, the management system receives the assessment from the sensor. In some examples, the management system may receive the assessment as a push message from the sensor. In some examples, the management system may poll the sensor asking for the assessment, if any, and receive the assessment responsive to such polling. Further, at step 408, the management system may report the assessment via a dashboard.

Turning now to FIG. 5, another example method 500 for evaluating an IT infrastructure's vulnerability to network attacks is presented. In particular, at step 502, a management system may monitor one or more first network sources to identify any newly reported attack. In some examples, a network source repository hosted on a backend system is configured with a list of the first network sources such as websites, databases, repositories, and/or news media that maintain a record of discovered network attacks. The management system may reference the network source repository and monitor one or more of the first network sources continuously, at regular intervals, and/or at random intervals, to look for newly discovered network attacks. At step 504, the management system may perform a check to determine whether a new network attack(s) is discovered at step 502. If it is determined that no new network attack(s) is discovered (i.e., NO at step 504), the management system may continue to monitor the one or more first network sources.

However, if it is determined that a new network attack(s) is discovered (i.e., YES at step 504), the management system, at step 506, may monitor one or more second network sources to identify a vulnerability evaluation template corresponding to the network attack. The network source repository hosted on the backend system is configured with a list of the second network sources such as websites, databases, repositories, and/or news media that maintain a record of vulnerability evaluation templates for known and/or newly discovered network attacks. The management system may be configured to monitor one or more of the second network sources continuously, at regular intervals, and/or at random intervals, to look for vulnerability evaluation templates corresponding to the newly discovered network attack(s) at step 502.

At step 508, the management system may store the vulnerability evaluation template corresponding to the network attack in a template repository. In some instances, when a vulnerability evaluation template is not found from the second network source, the management system may generate an alert for the support team to develop the vulnerability evaluation template corresponding to the discovered network attack. The support team may develop the vulnerability evaluation template and upload it to the template repository.

At step 510, the management system may perform a check to determine whether the vulnerability evaluation template corresponding to the network attack is uploaded in the template repository. At step 510, if it is determined that no new vulnerability evaluation template is uploaded in the template repository (i.e., NO at step 510), the management system may continue to monitor the second network sources at step 506. However, at step 510, if it is determined that any new vulnerability evaluation template is uploaded in the template repository (i.e., YES at step 510), at step 512, the management system may transmit the vulnerability evaluation template to the sensor deployed in the IT infrastructure. On receiving the vulnerability evaluation template, the sensor may execute the vulnerability evaluation template. Accordingly, the sensor may generate an assessment indicative of the IT infrastructure's vulnerability to the network attack. In particular, the assessment may indicate whether the IT infrastructure has passed (via a success indicator, such as, “passed” or any other alphanumeric expression) or failed (via a failure indicator, such as, “failed” or any other alphanumeric expression) a vulnerability test corresponding to the network attack. The IT infrastructure passing the vulnerability test may indicate that the IT infrastructure is capable of withstanding the network attack. In some examples, in case IT infrastructure has failed in the vulnerability test, the assessment generated by the sensor may also include information about the network devices in the IT infrastructure that are vulnerable to the network attack. The sensor may transmit the assessment to the management system.

At step 514, the management system receives the assessment from the sensor. At step 516, the management system may perform a check whether the IT infrastructure is vulnerable to the network attack based on the assessment. At step 516, the management system may analyze the assessment to look for the success or failure indicator. If the assessment includes the success indicator, the management system determines that the IT infrastructure has passed the evaluation and is safe against the discovered network attack. However, if the assessment includes the failure indicator, the management system determines that the IT infrastructure has failed the evaluation and is vulnerable to the discovered network attack. At step 516, if it is determined that IT infrastructure is not vulnerable to the network attack (i.e., NO at step 516), the management system may continue to monitor for the new network attacks at step 502. However, at step 516, if it is determined that the IT infrastructure is vulnerable to the network attack (i.e., YES at step 516), at step 518, the management system may generate an issue. The issue may be stored as an entry in an issue repository. The issue may include information about the network attack, the corresponding vulnerability evaluation template that was executed, the assessment generated by the sensor, and/or a list of network devices of the IT infrastructure that are found vulnerable to the network attack.

Further, at step 520, the management system may report the assessment via a dashboard. Reporting the assessment via the dashboard may entail executing one or more of steps 522 and 524. For example, at step 522, the management system may display an alert on the dashboard indicating the issue. In one example, displaying the alert may include displaying an identity of the network device that is found vulnerable. Further, in some examples, at step 524 the management system may recommend a corrective action to secure the IT infrastructure with respect to the network attack. For example, the management system may display a list of the network devices found to be vulnerable and respective corrective actions. The corrective action may include one or more of a firmware update, a software update, a configuration change, and/or a security patch for the network devices that are found vulnerable to the network attack. Upon implementing the corrective action or upon determining that the IT infrastructure has passed the vulnerability test, the IT infrastructure is considered to be capable of withstanding the network attack.

Moreover, in some examples, at step 526, the management system may send a notification to a network administrator of the IT infrastructure in response to determining that the IT infrastructure is vulnerable to the network attack. The notification may be sent using one or more messaging techniques, including but not limited to, displaying an alert message on a display, via a text message such as a short message service (SMS), a Multimedia Messaging Service (MMS), and/or an email, via an audio alarm, video, or an audio-visual alarm, a phone call, etc. In some examples, the notification may also include a recommendation on the corrective action. Use of such notifications free-up the network administrator from continuously monitoring the dashboard. The network administrator may implement the corrective action upon receiving such notification.

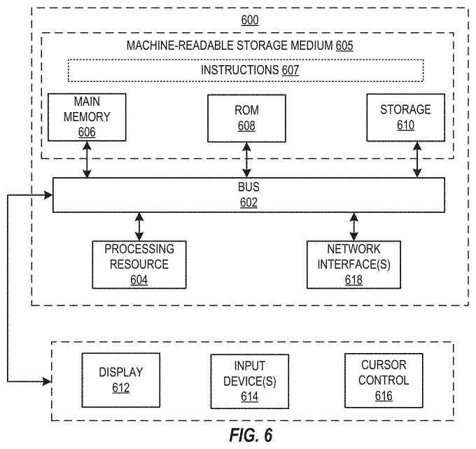

FIG. 6 depicts a block diagram of an example computing system 600 in which various of the examples described herein may be implemented. In some examples, the computing system 600 may be representative of a management system (e.g., the management system 162 of FIG. 1) and can perform various operations performed by the management system. The computing system 600 may include a bus 602 or other communication mechanisms for communicating information, a hardware processor, also referred to as processing resource 604, coupled to the bus 602 for processing information. The processing resource 604 may be, for example, one or more general-purpose microprocessors. The computing system 600 may also include a non-transitory machine-readable storage medium 605 communicatively coupled to the bus 602. In some examples, the machine-readable storage medium 605 may include a main memory 606, such as a random-access memory (RAM), cache and/or other dynamic storage devices, coupled to the bus 602 for storing information and instructions to be executed by the processing resource 604. The main memory 606 may also be used for storing temporary variables or other intermediate information during the execution of instructions to be executed by the processing resource 604. Such instructions, when stored in storage media accessible to the processing resource 604, render the computing system 600 into a special-purpose machine that is customized to perform the operations specified in the instructions.

The machine-readable storage medium 605 may further include a read-only memory (ROM) 608 or other static storage device coupled to the bus 602 for storing static information and instructions for the processing resource 604. Further, in the machine-readable storage medium 605, a storage device 610, such as a magnetic disk, optical disk, or USB thumb drive (Flash drive), etc., may be provided and coupled to the bus 602 for storing information and instructions.

Further, in some implementations, the computing system 600 may be coupled, via the bus 602, to a display 612, such as a liquid crystal display (LCD) (or touch-sensitive screen), for displaying information to a computer user. In some examples, an input device 614, including alphanumeric and other keys (physical or software generated and displayed on touch-sensitive screen), may be coupled to the bus 602 for communicating information and command selections to the processing resource 604. Also, in some examples, another type of user input device may be a cursor control 616, such as a mouse, a trackball, or cursor direction keys may be connected to the bus 602. The cursor control 616 may communicate direction information and command selections to the processing resource 604 for controlling cursor movement on the display 612. In some other examples, the same direction information and command selections as cursor control may be implemented via receiving touches on a touch screen without a cursor.

In some examples, the computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 600 also includes a network interface 618 coupled to bus 602. The network interface 618 provides a two-way data communication coupling to one or more network links that are connected to one or more local networks. For example, the network interface 618 may be an integrated services digital network (ISDN) card, cable modem, satellite modem, or a modem to provide a data communication connection to a corresponding type of telephone line. As another example, the network interface 618 may be a local area network (LAN) card or a wireless communication unit (e.g., Wi-Fi chip/module).

In some examples, the machine-readable storage medium 605 (e.g., one or more of the main memory 606, the ROM 608, or the storage device 610) may store instructions 607 which when executed by the processing resource 604 may cause the processing resource 604 to execute one or more of the methods described hereinabove. The instructions 607 may be stored on any of the main memory 606, the ROM 608, or the storage device 610. In some examples, the instructions 607 may be distributed across one or more of the main memory 606, the ROM 608, or the storage device 610.

The instructions 607 may include instructions which when executed by the processing resource 604 may cause the processing resource 604 to determine whether a vulnerability evaluation template corresponding to a network attack is uploaded in a template repository. The instructions 607 may include instructions which when executed by the processing resource 604 may cause the processing resource 604 to transmit the vulnerability evaluation template to a sensor deployed in an IT infrastructure in response to determining that the vulnerability evaluation template is uploaded in the template repository. The instructions 607 may include instructions which when executed by the processing resource 604 may cause the processing resource 604 to receive the assessment from the sensor and report the assessment via a dashboard. In some examples, the instructions 607 may include instructions which when executed by the processing resource 604 may cause the processing resource 604 to perform one or more of the steps described in FIGS. 4 and 5.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, etc., may be used herein to describe various elements, these elements should not be limited by these terms, as these terms are only used to distinguish one element from another unless stated otherwise or the context indicates otherwise.

What is claimed is:

1. A method comprising:
determining, by a management system, whether a vulnerability evaluation template corresponding to a network attack is uploaded in a template repository;
in response to determining that the vulnerability evaluation template is uploaded in the template repository, transmitting, by the management system, the vulnerability evaluation template to a sensor deployed in an information technology (IT) infrastructure, wherein the vulnerability evaluation template, when executed by the sensor, causes the sensor to generate an assessment indicative of a vulnerability of the IT infrastructure to the network attack;
receiving, by the management system, the assessment from the sensor; and
reporting, by the management system, the assessment via a dashboard.

2. The method of claim 1, further comprising monitoring, by the management system, one or more first network sources to identify newly reported network attacks, wherein the network attack is one of the newly reported network attacks.

3. The method of claim 1, further comprising monitoring, by the management system, one or more second network sources to identify the vulnerability evaluation template corresponding to the network attack.

4. The method of claim 1, further comprising storing, by the management system, the vulnerability evaluation template corresponding to the network attack in the template repository.

5. The method of claim 1, further comprising:
determining, by the management system, whether the IT infrastructure is vulnerable to the network attack based on the assessment; and
generating, by the management system, an issue in response to determining that the IT infrastructure is vulnerable to the network attack.

6. The method of claim 5, wherein reporting the assessment comprises displaying an alert indicating the issue on the dashboard.

7. The method of claim 5, further comprising sending, by the management system, a notification to an administrator of the IT infrastructure in response to determining that the IT infrastructure is vulnerable to the network attack.

8. The method of claim 5, wherein reporting the assessment comprises recommending a corrective action to secure the IT infrastructure with respect to the network attack.

9. The method of claim 8, wherein the corrective action comprises one or more of a firmware update, a software update, a configuration change, or a security patch for one or more network devices in the IT infrastructure.

10. A backend system comprising:
a template repository; and
a management system communicatively coupled to the template repository, wherein the management system is configured to:
determine whether a vulnerability evaluation template corresponding to a network attack is uploaded in the template repository;
transmit the vulnerability evaluation template to a sensor deployed in an IT infrastructure in response to determining that the vulnerability evaluation template is uploaded in the template repository, wherein the vulnerability evaluation template, when executed by the sensor, causes the sensor to generate an assessment indicative of a vulnerability of the IT infrastructure to the network attack;
receive the assessment from the sensor; and
report the assessment via a dashboard.

11. The backend system of claim 10, further comprising a device gateway communicatively coupled to the management system and the sensor, wherein the management system transmits the vulnerability evaluation template to the sensor via the device gateway.

12. The backend system of claim 10, wherein the dashboard is accessible on a user portal.

13. The backend system of claim 12, further comprising an application programming interface (API) gateway communicatively coupled to the user portal and management system, wherein the management system transmits information related to the assessment to the user portal via the API gateway.

14. The backend system of claim 12, further comprising a network source repository storing information corresponding to one or more first network sources and one or more second network sources, wherein the management system uses the one or more first network sources to identify newly reported network attacks, and wherein the management system uses the one or more second network sources to identify the vulnerability evaluation template corresponding to the network attack.

15. The backend system of claim 10, wherein reporting the assessment comprises recommending a corrective action to secure the IT infrastructure with respect to the network attack.

16. The backend system, wherein the corrective action comprises one or more of a firmware update, a software update, a configuration change, or a security patch for one or more network devices in the IT infrastructure.

17. The backend system of claim 10, wherein management system evaluating IT infrastructure's vulnerability by proactively transmitting the vulnerability evaluation template to the sensor results in reducing manual intervention and protecting the IT infrastructure from the network attack thereby improving user experience in the IT infrastructure.

18. A system comprising:
an IT infrastructure;
a backend system coupled to the IT infrastructure, wherein the backend system comprises:
a template repository; and
a management system communicatively coupled to the template repository, wherein the management system is configured to:
determine whether a vulnerability evaluation template corresponding to a network attack is uploaded in the template repository;
transmit the vulnerability evaluation template to a sensor deployed in the IT infrastructure in response to determining that the vulnerability evaluation template is uploaded in the template repository, wherein the vulnerability evaluation template, when executed by the sensor, causes the sensor to generate an assessment indicative of a vulnerability of the IT infrastructure to the network attack;
receive the assessment from the sensor; and
report the assessment via a dashboard.

19. The system of claim 18, wherein the IT infrastructure comprises a plurality of sites each comprising one or more network devices, and wherein the sensor is deployed in a site of the plurality of sites.

20. The system of claim 18, further comprising a network source repository storing information corresponding to one or more first network sources and one or more second network sources, wherein the management system uses the one or more first network sources to identify newly reported network attacks, and wherein the wherein the management system uses the one or more second network sources to identify the vulnerability evaluation template corresponding to the network attack.
